(19) United States
(12) Patent Application Publication
(10) Pub. No.: US 2026/0241423 A1
(43) Pub. Date: Aug. 20, 2026

(54) PIPE CLEANING MACHINE

(71) Applicant: Elran shmuel SHMUELI, Kiryat Ono (IL)

(72) Inventor: Elran shmuel SHMUELI, Kiryat Ono (IL)

(21) Appl. No.: 19/537,606

(22) Filed: Feb. 12, 2026

(30) Foreign Application Priority Data
Feb. 19, 2025 (IL) 319099

(51) Int. Cl. B08B 9/043; B08B 9/045; B08B 9/047

(52) U.S. Cl. CPC B08B 9/0436; B08B 9/045; B08B 9/047

(57) ABSTRACT

A pipe cleaning machine, including: a stationary structure; a round structure, for being rotatable in relation to the stationary structure; a motorized device disposed within the round structure, the motorized device including a package including a first portion for rotating an axle in relation to the first portion, the first portion of the package being fixed near and parallel to a tangent of the round rotatable structure, for disposing the axle parallel to the tangent of the round rotatable structure; and a flexible bit extension for being rollable within the rotatable structure, wherein an end of the flexible bit extension is fixed to the axle.

### CROSS-REFERENCE TO RELATED APPLICATIONS

This application claims the benefit of priority from Israel Patent Application No. 319099, filed February 19, 2025, the disclosure of which is incorporated herein by reference.

### FIELD OF THE INVENTION

The invention relates to the field of sewer pipes cleaning.

### BACKGROUND OF THE INVENTION

Machines for cleaning, milling, and unclogging sewer pipes, are impractical, inconvenient to operate and carry, very heavy, cumbersome, and do not open and clean the pipes optimally.

There is a long felt need to provide a solution to the above-mentioned and other problems of the prior art.

### SUMMARY OF THE INVENTION

A pipe cleaning machine (10), including:
a stationary structure;
a round structure, for being rotatable in relation to the stationary structure;
a motorized device being fixed near and parallel to the tangent of the round rotatable structure.

### BRIEF DESCRIPTION OF THE DRAWINGS

Embodiments, features, and aspects of the invention are described herein in conjunction with the following drawings:

FIG. 1 is a perspective view of a pipe cleaning machine according to one embodiment, disassembled.

FIG. 2 is a side view of the rotatable structure of FIG. 1.

FIG. 3 is the perspective view of the pipe cleaning machine, assembled

FIG. 4 depicts the motorized device of FIG. 2 alone.

FIG. 5 is the perspective view of the pipe cleaning machine of FIG. 1, assembled.

The drawings are not necessarily drawn to scale.

### DETAILED DESCRIPTION

The invention will be understood from the following detailed description of embodiments of the invention, which are meant to be descriptive and not limiting. For the sake of brevity, some well-known features are not described in detail.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

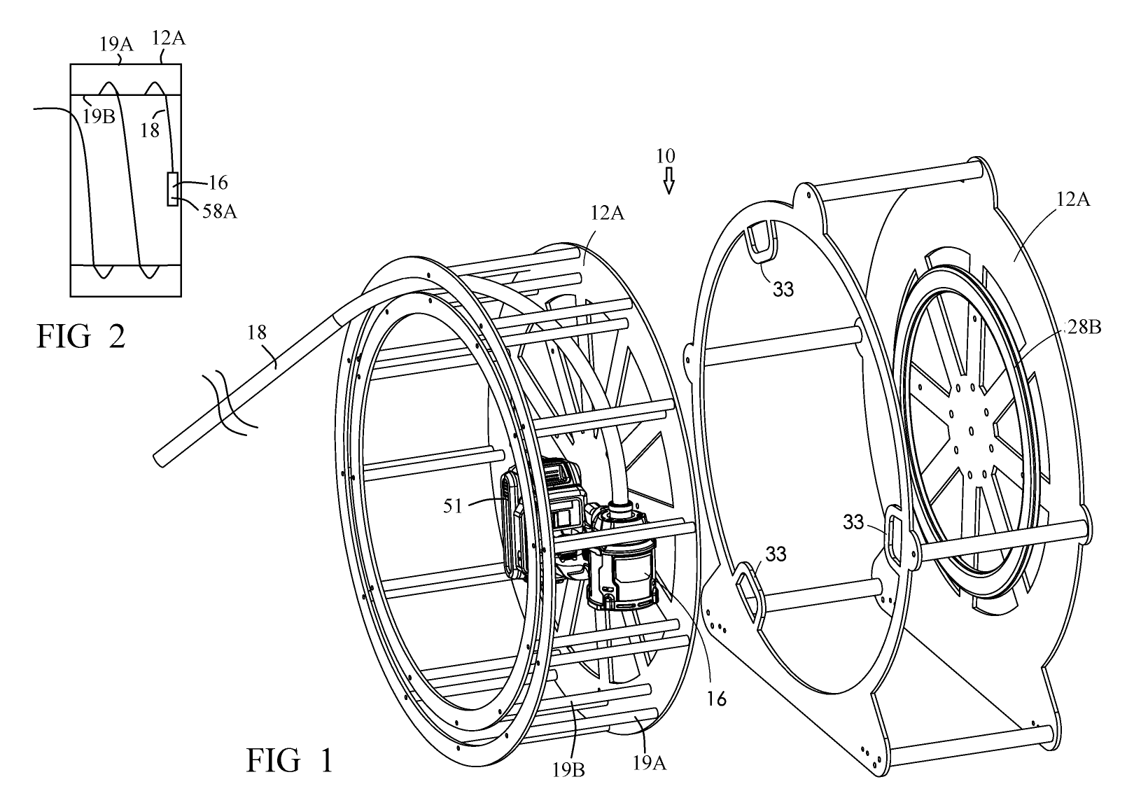

FIG. 1 is a perspective view of a pipe cleaning machine according to one embodiment, disassembled.

The term “flexible bit extension” refers herein to a flexible pipe housing a firm flexible cable ending with a bit adapter, such that the cable is rotatable in relation to the pipe, for rotating the bit adapter.

A pipe cleaning machine 10 includes according to one embodiment, a stationary round structure 12A; a rotatable round structure 12B, for being housed by stationary structure 12A, and for being rotatable in relation to stationary structure 12A; a motorized device 16 powered by a battery 51, and being fixed to rotatable structure 12B; a flexible bit extension 18, extending from motorized device 16 and ending with a bit adapter 52, and being rollable on rotatable structure 12B.

FIG. 2 is a side view of the rotatable structure of FIG. 1.

Rotatable structure 12B is wide for allowing a plurality (two shown) of rolls of flexible bit extension 18, one aside the other.

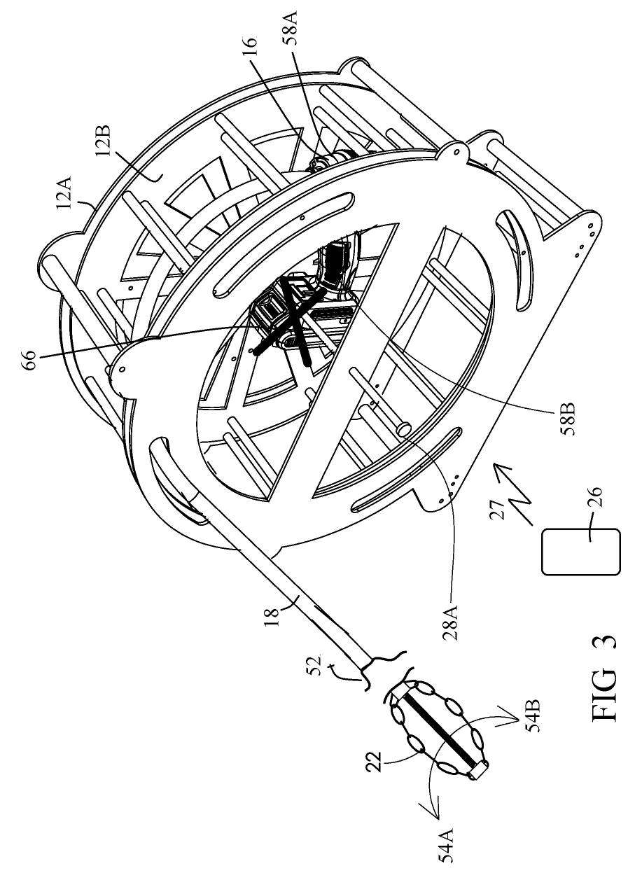

FIG. 3 is the perspective view of the pipe cleaning machine, assembled

Rotating rotatable structure 12B in relation to stationary round structure 12A, through an axle 28A, rolls or unrolls flexible bit extension 18 on rotatable structure 12B.

Turning on motorized device 16, such as wirelessly (27) by a transmitter 26, rotates bit adapter 52, to which a bit 22 for cleaning and milling a sewer pipe is connectable. Motorized device 16 may provide clockwise 54A or counter clockwise rotation 54B.

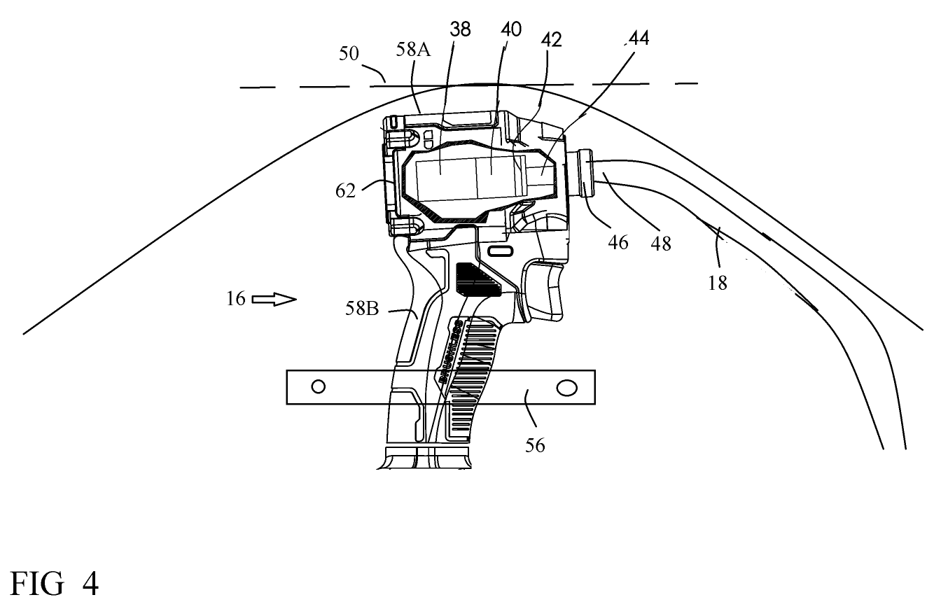

FIG. 4 depicts the motorized device of FIG. 2 alone.

Motorized device 16 includes the following components disposed sequentially along a line one after the other: a motor 38; a planetary gear 40; a ratchet 42; a powered axle 44; and a fastener 46, for fastening the end 48 of flexible bit extension 18.

Motor 38, planetary gear 40, ratchet 42, powered axle 44, fastener 46, and end 48 of flexible bit extension 18 are fixed near and parallel to the tangent 50 of rotatable round structure 12B, for decreasing bending of flexible bit extension 18.

Motor 38, planetary gear 40, and ratchet 42 are packaged by a portion 58A of a package 62. Motor 38, planetary gear 40, and ratchet 42 rotate in relation to portion 58A..

Package 62 must as well be fixed to near tangent 50 of rotatable round structure 12B. For this fixing, package 62 includes a portion 58B, extending right angled from portion 58A, for fixing portion 58B to the center of rotatable round structure 12B, by a fixing element 56, such as a ring.

Referring again to FIG. 3, portion 58B of package 62 being disposed at the center of rotatable round structure 12B might encounter axle 28A disposed as well at the center of rotatable round structure 12B and of stationary round structure 12A crossing from side to side, thus occupying (66) it.

Referring again to FIG. 1, a large diameter bearing 28B, fixed to one side only of stationary round structure 12A and to one side only of rotatable round structure 12B is applied for rotating therebetween, rather than axle 28A of FIG. 3 crossing from one side to side.

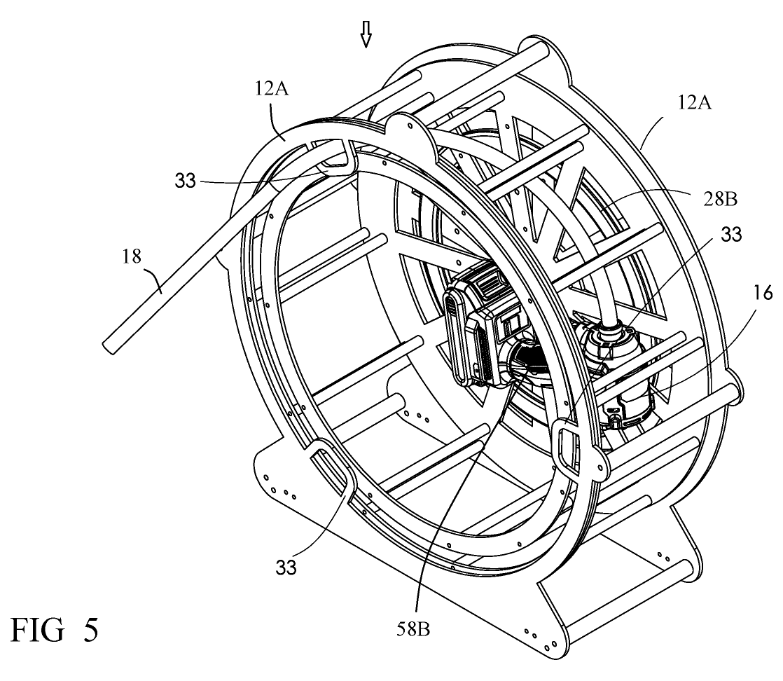

FIG. 5 is the perspective view of the pipe cleaning machine of FIG. 1, assembled.

Large diameter bearing 28B does not occupy the space within rotatable round structure 12B required for fixing portion 58B of package 62 to the center of rotatable round structure 12B.

Large diameter bearing 28B further allows decreasing portions of stationary round structure 12A, for reducing weight and decreasing its diameter.

Thus, in one aspect, the invention is directed to a pipe cleaning machine (10), including:
a stationary structure (12A); a round structure (12B), for being rotatable in relation to the stationary structure (12A);
a round structure (12B), for being rotatable in relation to the stationary structure (12A);
a motorized device (16) disposed within the round structure (12B), the motorized device (16) including a package (62) including a first portion (58A) for rotating an axle (44) in relation to the first portion (58A), the first portion (58A) of the package (62) being fixed near and parallel to a tangent (50) of the round rotatable structure (12B), for disposing the axle (44) parallel to the tangent (50) of the round rotatable structure (12B); and
a flexible bit extension (18) for being rollable within the rotatable structure (12B), wherein an end (48) of the flexible bit extension (18) is fixed to the axle (44),
thereby the fixing of the end (48) of the flexible bit extension (18) reduces bending of the of the flexible bit extension (18).

The package (62) may further include a second portion (58B) extending from the first portion (58A) towards a center of the rotatable structure (12B),
wherein the fixing of the first portion (58A) is by fixing the second portion (58B) to the round rotatable structure (12B):

The rotatablity of the round structure (12B) in relation to the stationary structure (12A) may be applied by a single bearing (28B) therebetween,
thereby not occupying (66) the center of the round structure (12B) by an axle (28A) therebetween.

The motorized device (16) may be a screw-driver.

The pipe cleaning machine (10) may further include:
a transmitter (26), for wirelessly (27) operating the motorized device (16).

In the figures and description herein, the following reference numbers (Reference Signs List) have been mentioned:
- number 10 denotes the pipe cleaning machine according to one embodiment of the invention;
- 12A: stationary structure;
- 12B: rotatable round structure;
- 16: motorized device, such as a screwdriver;
- 18: flexible bit extension;
- 19A: external rod;
- 19B: internal rod for supporting flexible bit extension 18;
- 22: bit for cleaning;
- 26: transmitter;
- 27: wireless communication;
- 28B: axle;
- 28B: bearing;
- 33: threading slit of stationary structure 12A;
- 38: motor;
- 40: planetary gear;
- 42: ratchet;
- 44: axle;
- 46: fastener;
- 48: end of flexible bit extension 18;
- 50: tangent;
- 51: battery;
- 52: bit adapter;
- 54A: clockwise rotation of bit 22;
- 54B: counterclockwise rotation;
- 58A, 58B: portions of package 62;
- 62: package of motorized device 16;
- 66: axle 28A occupying the center.

The foregoing description and illustrations of the embodiments of the invention have been presented for the purpose of illustration, and are not intended to be exhaustive or to limit the invention to the above description in any form.

Any term that has been defined above and used in the claims, should be interpreted according to this definition.

The reference numbers in the claims are not a part of the claims, but rather used for facilitating the reading thereof. These reference numbers should not be interpreted as limiting the claims in any form.

What is claimed is:

1. A pipe cleaning machine, comprising:
a stationary structure;
a round structure, for being rotatable in relation to said stationary structure;
a motorized device disposed within said round structure, said motorized device comprising a package comprising a first portion for rotating an axle in relation to said first portion, said first portion of said package being fixed near and parallel to a tangent of said round rotatable structure, for disposing said axle parallel to said tangent of said round rotatable structure; and
a flexible bit extension for being rollable within said rotatable structure, wherein an end of said flexible bit extension is fixed to said axle,
thereby said fixing of said end of said flexible bit extension reduces bending of said of said flexible bit extension.

2. The pipe cleaning machine according to claim 1, wherein said package further comprises a second portion extending from said first portion towards a center of said rotatable structure,
wherein said fixing of said first portion is by fixing said second portion to said round rotatable structure:

3. The pipe cleaning machine according to claim 1, wherein said rotatablity of said round structure in relation to said stationary structure is applied by a single bearing therebetween,
thereby not occupying a center of said round structure by an axle therebetween.

4. The pipe cleaning machine according to claim 1, wherein said motorized device comprises a screw-driver.

5. The pipe cleaning machine, according to claim 1, further comprising:
a transmitter, for wirelessly operating said motorized device.
